(19) United States
(12) Patent Application Publication
(10) Pub. No.: US 2003/0142902 A1
(43) Pub. Date: Jul. 31, 2003

(54) Optical device

(75) Inventor: Atsushi Sugitatsu, Hyogo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/191,404

(22) Filed: Jul. 10, 2002

(30) Foreign Application Priority Data
Jan. 25, 2002 (JP) 2002-016659

(51) Int. Cl. G02B 6/26; G02B 6/10

(52) U.S. Cl. 385/27; 385/129; 385/122

(57) ABSTRACT

An optical device having a waveguide that is formed in a photonic crystal and is provided with a special function utilizing a property specific to the photonic crystal is obtained. The waveguide device includes a waveguide formed in the photonic crystal having a periodic structure formed of at least two kinds of optical mediums. The waveguide is configured not to satisfy arrangement of the periodic structure so as to pass the light of a frequency in a photonic band gap range of the photonic crystal. At a prescribed portion of the waveguide, an optical non-linear medium having linear response as well as quadratic or higher-order non-linear response to the incoming energy of the photoelectric field is provided.

### BACKGROUND OF THE INVENTION

1. Field of the Invention

The present invention relates to an optical device employing a photonic crystal.

2. Description of the Background Art

A photonic crystal is a structure having periodic distribution of refractive indices, with its period in a space being on the order of optical wavelengths. Analysis of various optical properties of the light within a crystal has been attempted employing a band theory used in analysis of the energy structure of electrons within a crystal. In particular, with advancement of micromachining techniques in recent years, microfabrication on the order of the optical wavelengths has become possible, which has allowed, beyond a theory itself, substantiation of the theory and feedback from experimentation to the theory. With the theory and experimentation stimulating each other, research and development have vigorously been made worldwide.

In regard to the photonic crystal, the idea of a photonic band, which explains dispersion of light based on the similarity to the band structure of electrons in a crystal, is very important. This idea was introduced by Yablonovitch at the University of California, Los Angels (UCLA), who related (e1) energy E, (e2) momentum p and (e3) Schrödinger equation of an electron to (w1) frequency ω, (w2) wave number k and (w3) wave equation of light. Using this idea, a photonic band gap (PBG) forbidding propagation of light in every direction was predicted, and the photonic crystal was fabricated based on the prediction. The presence of PBG has been proved.

When a defect causing disorder of the periodic structure is introduced into such a photonic crystal, light of a wave number vector included in the PBG which is not permitted in the peripheral portion thereof is allowed to locally exist in the relevant defect portion. As a result, if the defect portion is shaped into a line, for example, the portion can function as a waveguide. Different from ordinary waveguides, such a waveguide exhibits significant dispersibility, and its wave-guiding mechanism can be altered by changing permittivity or dielectric constant of a certain material thereof. Further, unlike the conventional waveguides, it can implement a waveguide structure having a right-angled bending with negligible loss. Still further, because of its great degree of freedom in controlling the guided light by an electromagnetic field, it is possible to arbitrarily change the shape of the mode cross section, or to increase or decrease the size of the mode cross section. Utilizing such properties, it is possible to provide a photonic crystal with a high degree of variability and controllability, by increasing the non-linear effect or by combining an existing optical non-linear medium with the photonic crystal. As a result, implementation of an optical device different from the conventional ones is expected.

There is an example (Japanese Patent Laying-Open No. 11-330619) to use a photonic crystal to configure an optical device having functions of light emission, light amplification and light modulation. However, an example in which a waveguide formed within a photonic crystal is provided with or increased in optical non-linearity utilizing a property specific to the photonic crystal has been unknown to date.

### SUMMARY OF THE INVENTION

An object of the present invention is to provide an optical device having a waveguide that is formed within a photonic crystal and is provided with a special function utilizing a property specific to the photonic crystal.

The optical device of the present invention is a waveguide device having a waveguide formed within a photonic crystal having a periodic structure formed of at least two kinds of optical mediums, wherein the waveguide is formed not to satisfy arrangement of the periodic structure so as to pass light of a frequency within a photonic band gap range of the photonic crystal. In this waveguide device, an optical medium (optical non-linear medium) having not only a linear response but also a quadratic or higher-order non-linear response with respect to an incoming energy of the photoelectric field is placed at a prescribed portion of the waveguide.

Using this optical non-linear medium, optical wavelengths can be shifted. Since a refractive angle at the interface between the optical non-linear medium and the adjacent waveguide differs for each wavelength, optical paths can also be changed. It is well known that the photonic crystal has non-linear relation between frequency and wavelength. Although the present invention is naturally intended to utilize such non-linearity characteristic to the photonic crystal, it additionally incorporates the optical non-linear medium as described above.

The waveguide formed not to satisfy the arrangement of the periodic structure may be any structure disturbing the periodicity of the photonic crystal. For example, it may be a lattice defect introduced into a photonic crystal as a base material, or it may be a material of another element. For example, the photonic crystal may be formed as a photonic crystal fiber (PC fiber), and the waveguide may be placed as a core of the PC fiber.

The optical non-linear medium, with the waveguide being located in a unique portion other than a simple linear continuous portion or in a preceding portion of the unique portion, may function as an optical path changing device that receives light directed to the optical non-linear medium and changes its optical path for emission. The unique portion other than the simple linear continuous portion may be a bending portion of the waveguide, a branch portion where one waveguide is branched into a plurality of waveguides, a merge portion where a plurality of waveguides are merged into a fewer number of waveguides or particularly into a single waveguide, or a crossing portion where a plurality of waveguides cross with each other. With this configuration, it becomes possible to arbitrarily change the optical path at the unique portion. In addition, the optical non-linear medium, with the waveguide being located in a unique portion other than a simple linear continuous portion or in a preceding portion of the unique portion, may function as a luminous flux changing device that receives light directed to the optical non-linear medium and changes its luminous flux for emission.

Further, the optical non-linear medium may be placed in a meeting portion where at least two waveguides meet and a fewer number of waveguides go out therefrom, to receive lights propagated through the at least two waveguides and bend the lights to the outgoing waveguides for emission. Still further, the optical non-linear medium may be placed in a branch portion where a waveguide is branched into at least two waveguides which go out therefrom.

The optical non-linear medium may be a medium whose degree of non-linearity can be controlled and changed by external control means. With this configuration, the degree of non-linearity can be controlled and changed from the outside, so that it is possible to intensify the function provided by the optical device or enlarge the range of application of the optical device. The externally controllable non-linear medium may be any of electro-optic material, optoacoustic material, temperature driven material and stress driven material. With such a material, it becomes possible to control the non-linearity using voltage application, acoustic wave application, current application and others, at high speed and with highly reliable response.

The foregoing and other objects, features, aspects and advantages of the present invention will become more apparent from the following detailed description of the present invention when taken in conjunction with the accompanying drawing.

### BRIEF DESCRIPTION OF THE DRAWING

FIG. 1 shows optical non-linear mediums placed within a photonic crystal of an optical device according to an embodiment of the present invention.

### DESCRIPTION OF THE PREFERRED EMBODIMENTS

Hereinafter, embodiments of the present invention will be described with reference to the drawing.

### First Embodiment

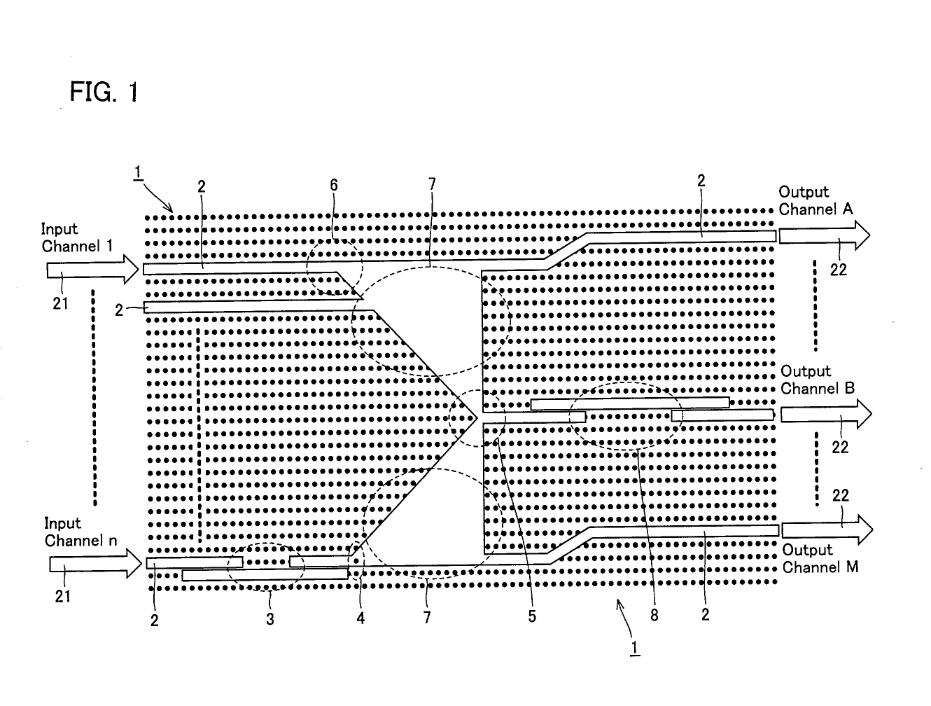

FIG. 1 shows an optical device having integrated photonic crystal structures according to the first embodiment of the present invention. The crystal structures shown in FIG. 1 as a whole correspond to a structure 1 constituting the photonic crystal having periodically changing refractive indices. A linear defect formed within the structure 1 functions as a waveguide 2. A signal light 21 that entered into waveguide 2 via an input signal channel n has its wavelength shifted with non-linear effects within the waveguide or in its adjacent portion 3. At this time, it is configured to satisfy a phase matching condition using great dispersibility of the photonic crystal. Alternatively, the cross-sectional shape of the guided light is decreased or the photoelectric field distribution is localized in the waveguided direction, to increase the strength of the electric field and thus to improve the wavelength shifting efficiency. The above-described optical non-linear portion functions as a wavelength shifter.

Materials employable as wavelength shifting materials include: semiconductor materials such as GaAs and GaP; dielectric materials like LiNbO₃, LiTaO₃, KTP(KTiOPO₄), KDP(KH₂PO₄), BBO(β-BaB₂O₄), LBO(LiB₃O₅), PBO, CLBO(CsLiB₆O₁₀); and other materials including Si and SiO₂ which were not conventionally paid attention to as non-linear materials due to their very small non-linear effects. As the materials for photonic crystal 1 itself, in addition to the materials mentioned above, semiconductor materials like InP, AlGaAs, InGaAsP, GaN, InGaAsN and various dielectric materials, various gases including air by introduction of cavities, organic materials like polymers, and any other material that is translucent and permitting a periodic change of the refractive indices may be employed.

With the configuration described above, selection of a non-linear optical material matching in phase with the waveguide becomes possible, which was difficult with a conventional bulk material. Further, localization of field distribution of the guided light leads to improvement of wavelength shifting efficiency. Still further, formation of a wavelength shifting device using the photonic crystal enables dramatic downsizing as compared with a conventional wavelength shifting device.

### Second Embodiment

In the second embodiment of the present invention, on/off of wavelength shifting is implemented in the optical device of the first embodiment, by using the electro-optic property, optoacoustic property of the non-linear optical material at the portion 3, or temperature dependency or stress dependency of the optical properties of the material. More specifically, the electro-optic effect, optoacoustic effect, or temperature or stress is altered to change the refractive index, to perform on/off of the phase matching condition. Alternatively, the beam spot size is increased or decreased for on/off of the non-linear effect.

As a result, it is possible to obtain a wavelength shifting device having a variable function in addition to the effects attained in the first embodiment.

### Third Embodiment

In the third embodiment of the present invention, a waveguide cross section at the wavelength shifting portion 3 as in the first and second embodiments is made smaller than in an ordinary waveguide structure, to strengthen the non-linear optical effect. As a result, it becomes possible to obtain the non-linear optical effect at the same level, with less modulation of the refractive index.

### Fourth Embodiment

In the fourth embodiment of the present invention, an optical path changing portion 4 is provided in the photonic crystal, which utilizes great dispersibility of the photonic crystal. Referring to FIG. 1, the signal light which entered from input channel n passes through wavelength shifting portion 3, and, whether or not the wavelength shifting has been conducted, its optical path is changed at the optical path changing portion 4. The optical path is changed taking advantage of the great dispersibility of the photonic crystal, by changing the refractive index of a portion of the structural body having periodically changing refractive indices. Such a change of the refractive index in a portion of the photonic crystal corresponds to a local change of the photonic crystal structure. A slight change in refractive index, i.e., phenomenon that the optical path greatly changes according to the shift in wavelength of the signal light at the relevant portion, is known as super prism phenomenon of the photonic crystal. The present embodiment utilizes this super prism phenomenon. Accordingly, in the present embodiment, optical path changing portion 4 does not necessarily include a non-linear optical material. All that is needed is that the refractive index can be changed by any of the electro-optic effect, optoacoustic effect, temperature change and stress change.

Employing the optical path changing structure of the present embodiment, branching of light, or, a function to greatly change the optical path only with refractive index modulation can readily be implemented. Further, by integrating the optical path changing structure of the present embodiment with the wavelength shifting device utilizing refractive index modulation as described above, considerable downsizing as compared with a conventional optical device is accomplished.

### Fifth Embodiment

In the fifth embodiment of the present invention, optical path changing portion 4 in the fourth embodiment is provided as a fixed material, and wavelength shifting portion 3 described in the second embodiment shifts the wavelength to a desired wavelength. A signal light with its wavelength thus shifted realizes optical path changing performance in accordance with the wavelength, by virtue of great dispersibility in the optical path changing portion 4, and changes the optical path.

As a result, branching of light is enabled using the wavelength shifting mechanism with refractive index modulation as well as great dispersibility of the photonic crystal. Furthermore, by integrally forming the optical path changing device and a wavelength shifting portion utilizing refractive index modulation as described above, much more downsizing than in the conventional case is accomplished.

### Sixth Embodiment

In the sixth embodiment of the present invention, high dispersibility of the photonic crystal is employed for merging lights in an optical path changing portion 5. This is the opposite case with the dispersion of light in the fourth embodiment.

In the present embodiment, in order that signal lights that entered input signal channels 1-n and arrived at optical path changing portion 5 may be emitted into the output signal channel B, the refractive index at optical path changing portion 5, and hence, the dispersion property is changed. In this case, again, the refractive index is slightly changed using any of the electro-optic effect, optoacoustic effect, temperature change and stress change, to guide the lights to the output signal channel B, employing the high dispersibility of the photonic crystal. Another property of the photonic crystal, known as super collimator phenomenon, to collimate lights of different wave numbers, or the lights thus having different wavelengths and different optical paths in the optical path changing portion, can also be utilized. Using this super collimator phenomenon, the light merging function with a slight change in refractive index can be implemented.

As a result, merging of lights, or, a function to greatly change the optical path only with refractive index modulation is realized. Further, by integrally forming the optical path changing device utilizing the refractive index modulation, downsizing of a much larger scale than in the conventional case is enabled.

### Seventh Embodiment

In the seventh embodiment of the present invention, the refractive index at the optical path changing portion 5 is fixed instead of being variable. A wavelength is shifted in the wavelength shifting portion 3 in the preceding stage, to obtain a wave number vector that allows desired optical path changing to be effected in the optical path changing portion 5.

As a result, branching of light, or, a function to greatly change the optical path only with refractive index modulation is realized. Moreover, by integrally forming the optical path changing device utilizing the refractive index modulation, considerable downsizing as compared with the conventional case becomes possible.

### Eighth Embodiment

Described in the eighth embodiment of the present invention is an optical signal switching device or an optical router having a combination of the optical path changing function and the wavelength shifting function as in the foregoing embodiments. A plurality of light signals with different wavelengths enter input signal channel 1, and their optical paths are switched in an optical path changing portion 6 according to their wavelengths. As shown in the output signal channel B, if a signal light to be output to a desired port has a wavelength different from the desired wavelength, the wavelength is shifted to the desired wavelength in a wavelength shifting portion 8 before being output.

As a result, an optical device switching the path of the light signal only with refractive index modulation is implemented. Further, by integrally providing such an optical device utilizing the refractive index modulation, downsizing of a much larger scale than in the conventional case becomes possible.

As such, the embodiments of the present invention have been described. They are merely illustrative, and the scope of the invention is not limited to these embodiments.

For example, the optical path changing portion with the optical non-linear medium also effects wavelength shifting to a certain extent. It does not exert only one of the functions. In fact, some of the embodiments of the present invention refer to the optical device wherein the optical non-linear medium is provided to exert both the wavelength shifting function and the optical path changing function. In the embodiments where only one of the functions has been described, the relevant function is solely utilized; however, it does not mean that the other function did not occur at all. The present invention includes any modification falling into the scope of the invention defined in the appended claims or the equivalent meaning and scope thereof.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An optical device having a waveguide formed within a photonic crystal having a periodic structure formed of at least two kinds of optical mediums, the waveguide being formed not to satisfy arrangement of said periodic structure so as to pass light of a frequency in a photonic band gap range of said photonic crystal,
an optical non-linear medium having linear response as well as quadratic or higher-order response with respect to an incoming energy of a photoelectric field being provided at a prescribed portion of said waveguide.

2. The optical device according to claim 1, wherein said optical non-linear medium functions as a wavelength shifter which shifts a wavelength of the light propagating through said waveguide.

3. The optical device according to claim 1, wherein said photonic crystal is formed as a photonic crystal fiber, and said waveguide is placed as a core of the photonic crystal fiber.

4. The optical device according to claim 1, wherein, with said waveguide being placed in a unique portion other than a simple linear continuous portion or a preceding portion of the unique portion, said optical non-linear medium functions as an optical path changing device which receives light directed to the optical non-linear medium and changes an optical path of the light for emission.

5. The optical device according to claim 1, wherein, with said waveguide being located in a unique portion other than a simple linear continuous portion or a preceding portion of the unique portion, said optical non-linear medium functions as a luminous flux changing device which receives light directed to the optical non-linear medium and changes a luminous flux of the light for emission.

6. The optical device according to claim 1, wherein said optical non-linear medium is placed in a meeting portion where at least two waveguides meet and a fewer number of waveguides go out therefrom, and receives lights propagated through said at least two waveguides and bends the lights to the outgoing waveguides for emission.

7. The optical device according to claim 1, wherein said optical non-linear medium is placed in a branch portion where one waveguide is branched into at least two waveguides going out therefrom.

8. The optical device according to claim 1, wherein said optical non-linear medium is a medium whose degree of non-linearity is controlled and changed by external control means.

9. The optical device according to claim 8, wherein said optical non-linear medium is any of electro-optic material, optoacoustic material, temperature driven material and stress driven material.
